(19) United States
(12) Patent Application Publication
(10) Pub. No.: US 2019/0349389 A1
(43) Pub. Date: Nov. 14, 2019

(54) COMMUNICATION SYSTEM, RELAY DEVICE, COMMUNICATION DEVICE AND COMMUNICATION METHOD

(71) Applicants: AutoNetworks Technologies, Ltd., Yokkaichi-shi , Mie (JP); Sumitomo Wiring Systems, Ltd., Yokkaichi-shi , Mie (JP); Sumitomo Electric Industries, Ltd., Osaka (JP)

(72) Inventor: Tomohiro Mizutani, Yokkaichi, Mie (JP)

(21) Appl. No.: 16/335,179

(22) PCT Filed: Sep. 6, 2017
(86) PCT No.: PCT/JP2017/032072

§ 371 Date: Mar. 20, 2019

(30) Foreign Application Priority Data
Sep. 21, 2016 (JP) 2016-184503

(51) Int. Cl. H04L 29/06; H04L 12/66; H04L 29/08

(52) U.S. Cl. CPC H04L 63/123; H04L 67/12; H04L 67/2842; H04L 12/66

(57) ABSTRACT

Provided is a communication system and a communication method that enable message transmission/reception using shared information whose value can change. A relay device relays communication between a plurality of communication lines connected to communication devices. The communication device and the relay device store shared information, generate a message in which shared information is used, transmit the generated message to another device, and receive a message from another device, and determine whether or not the received message is proper based on the shared information. At least one of the communication devices and the relay device transmits an update instruction for updating shared information to another device. The communication devices and the relay device determine that this message is a proper message if a message generated using shared information after being updated is received during a period from update of shared information until a predetermined period elapses.

### CROSS-REFERENCE TO RELATED APPLICATIONS

This application is the U.S. national stage of PCT/JP2017/032072 filed Sep. 6, 2017, which claims priority of Japanese Patent Application No. JP 2016-184503 filed Sep. 21, 2016.

### TECHNICAL FIELD

The present disclosure relates to a communication system having a configuration in which a relay device relays communication between a plurality of communication lines, a relay device, a communication device, and a communication method.

### BACKGROUND

In recent years, for example, in networks installed in vehicles, message transmission/reception using a message identifier (MAC: Message Authentication Code) has been suggested as a countermeasure for preventing unauthorized message transmission to the networks through connection of an unauthorized communication device, takeover of a regular communication device, and the like. However, a MAC is generated from an encryption key, which is shared by regular communication devices, and the information to be transmitted, and takes the same value for the same combination of an encryption key and information to be transmitted. Therefore, methods that use a MAC were not effective for a retransmission attack in which a regular message that was transmitted/received in a network in the past is acquired, and the acquired message is retransmitted.

Against message retransmission attacks, a countermeasure to inactivate previous regular messages can be taken by integrating information that periodically changes or the like into the calculation for generating a MAC. Note that, in order to realize this countermeasure, a plurality of communication devices in a network need to share information that changes periodically, and the communication devices need to change the shared information in synchronization.

In WO 2013/175633, a communication system is described in which communication devices in a network each generate a MAC using a check value, and transmit a message including this MAC, and it is determined whether or not the message is proper, based on comparison between the check value and a reproduction value reproduced from the MAC included in the received message. In the communication system described in WO 2013/175633, the check value of the communication devices is synchronized based on a message including a content for instructing update of the check value.

The method for synchronizing the check value using a specific message that is performed by the communication devices described in WO 2013/175633 can be operated without difficulty in a communication system that has a configuration in which a plurality of communication devices that transmit/receive messages are connected to one shared communication line. However, in a communication system having a configuration in which a plurality of communication lines are connected via a relay device such as a gateway or a router, and the communication devices connected to the respective communication lines asynchronously perform message transmission/reception, there is a risk that a synchronization error temporarily occurs due to a delay, collision, or the like of relay of a message for synchronizing the check value.

The present disclosure has been made in view of such circumstances, and aims to provide a communication system that enables message transmission/reception using shared information whose value can change, in a configuration in which a relay device relays communication between a plurality of communication lines, as well as a relay device, a communication device, and a communication method.

### SUMMARY

In a communication system according to the present disclosure, one or more communication devices are connected to a communication line, and communication between a plurality of such communication lines is relayed by a relay device, the communications device and the relay device each include a storage unit that stores shared information, a message generation unit that generates a message using the shared information, a message transmission unit that transmits, to the other devices, a message generated by the message generation unit, a message reception unit that receives a message from another device, and a determination unit that determines, based on the shared information, whether or not a message received by the message reception unit is proper, and at least one device out of the communication devices and the relay device includes an update instruction transmission unit that transmits, to the other devices, an update instruction for updating the shared information, the communication devices and the relay device further include an update unit that updates shared information stored in the storage unit when the update instruction is received, and, if the communication devices or the relay device receives a message generated using shared information that is not yet updated, during a period from update of the shared information until a predetermined period elapses, the determination unit determines that the message is a proper message.

In addition, in the communication system according to the present disclosure, the relay device may include a message correction unit that corrects, if a message generated using shared information that is not yet updated is received during a period from update of the shared information until a predetermined period elapses, the message to a message in which updated shared information is used, and relays the message corrected by the message correction unit.

In addition, in the communication system according to the present disclosure, a message that is generated by the message generation unit may include update state information indicating an update state of the shared information, and the determination unit determines whether or not a received message is proper, based on the shared information and the update state information included in the message.

In addition, in the communication system according to the present disclosure, the update state information may be information whose value changes in accordance with the update instruction based on a predetermined rule.

In addition, in the communication system according to the present disclosure, the update state information may be a toggle bit whose value is inverted in accordance with the update instruction.

In addition, in the communication system according to the present disclosure, a message that is generated by the message generation unit may include a message identifier generated based on the shared information and information included in the message, and the determination unit determines whether or not the message is proper, based on information and a message identifier included in a received message and the shared information stored in the storage unit.

In addition, a relay device according to the present disclosure that relays communication between a plurality of communication lines, to each of which one or more communication devices are connected, includes a storage unit that stores shared information that is shared with the communication devices, a message reception unit that receives, from the communication devices, a message generated using the shared information, a determination unit that determines, based on the shared information, whether or not a message received by the message reception unit is proper, an update unit that updates shared information stored in the storage unit, and a message correction unit that corrects, if a message generated using shared information that is not yet updated is received during a period from update of the shared information until a predetermined period elapses, the message to a message in which updated shared information is used.

In addition, a communication device according to the present disclosure includes a storage unit that stores shared information that is shared with the relay device, a message generation unit that generates a message using the shared information, a message transmission unit that transmits, to the other devices, a message generated by the message generation unit, a message reception unit that receives a message from another device, a determination unit that determines, based on the shared information, whether or not a message received by the message reception unit is proper, and an update unit that updates, when an update instruction of the shared information that is transmitted from another device is received, shared information stored in the storage unit, and if a message generated using shared information that is not yet updated is received during a period from update of the shared information until a predetermined period elapses, the determination unit determines that the message is a proper message.

In addition, in a communication method according to the present disclosure, one or more communication devices are connected to a communication line, and a relay device to which a plurality of such communication lines are connected relays communication between the communication lines, and the communication devices and the relay device store shared information, generate a message using the shared information and transmit the generated message to another device, and determine whether or not a message received from another device is proper, based on the shared information, at least one device out of the communication devices and the relay device transmits an update instruction to update the shared information, to another device, the communication devices and the relay device update the shared information when the update instruction is received, and if a message generated using shared information that is not yet updated is received during a period from update of the shared information until a predetermined period elapses, the communication devices or the relay device determine that the message is a proper message.

In the present disclosure, the communication system has a configuration in which one or more communication devices are connected to a communication line, a plurality of such communication lines are connected to a relay device, and the relay device relays communication between the communication lines. Protocols of communications performed on the communication lines do not necessarily need to be the same protocol, and the relay device may convert communication with different protocols and, relay the converted communication. In addition, a layered system configuration may be adopted in which a plurality of relay devices are connected to a further upstream relay device.

The communication devices and the relay device included in the communication system store shared information, and perform generation and transmission of a message to another device and determination on whether or not a message received from another device is proper, using the stored shared information. The shared information stored in the communication devices and the relay device is variable, and is updated in accordance with an update instruction that is transmitted by at least one device out of the communication devices and the relay device included in the communication system. Specifically, an update instruction transmitted by one device propagates through the network and is received by the communication devices and the relay device, and the communication devices and the relay device that received the update instruction update shared information stored therein respectively. Note that shared information may be updated in a predetermined cycle, such as every second, every minute, every hour, every day, or every week, and, for example, if the communication system is a communication system that is installed in a vehicle, shared information may be updated every time a certain event occurs, for example, every time an ignition signal of the vehicle changes to an on state.

There is a possibility that there is a collision, delay, or the like of an update instruction that is transmitted by one device during transmission, relay between communication lines, and the like. In view of this, the relay device of the communication system according to the present disclosure handles, as proper messages, both a message generated using shared information that is not yet updated and a message generated using updated shared information, during a period from a timing for updating shared information until a predetermined period elapses, and relays these messages. Alternatively, during a period from a timing for updating shared information until a predetermined period elapses, a communication device of the communication system according to the present disclosure receives, as proper messages, both a message generated using shared information that is not yet updated and a message generated using updated shared information. Note that, in a case of a device that transmits an update instruction, the timing for updating shared information can be a timing when shared information of the device was updated, a timing when an update instruction was transmitted, or the like, and in a case of a device that receives an update instruction, the timing for updating shared information can be a timing when an update instruction was received, a timing when shared information of this device was updated, or the like.

Accordingly, during a certain period until an update instruction transmitted by one device is received by all of the devices included in the communication system, a message generated using shared information that is not yet updated and a message generated using updated shared information can be transmitted/received. Thus, even in a communication system having a configuration in which a relay device relays communication between a plurality of communication lines, message transmission/reception using shared information whose value changes can be realized.

In addition, in the present disclosure, if the relay device receives a message generated using shared information that is not yet updated, the relay device corrects this message to a message in which updated shared information is used, and relays the corrected message. Accordingly, a communication device, to which the message is relayed, can receive the message in which updated shared information is used. Therefore, the communication device is not required to perform processing for handling, as a proper message, a message in which shared information that is not yet updated is used, and that has been received during a period from update of shared information until a predetermined period elapsed.

In addition, in the present disclosure, update state information indicating the update state of shared information is included in a message. The update state information can be information whose value changes in accordance with an update instruction in compliance with a predetermined rule, for example, a toggle bit whose value is inverted in accordance with an update instruction. As a result of such update state information being included in a message, the relay device and communication devices can easily determine whether the received message is a message in which shared information that is not yet updated is used, or a message in which updated shared information is used.

In addition, in the present disclosure, a device that transmits a message generates a message identifier based on shared information and information included in a message to be transmitted, and transmits the message that includes this message identifier to another device. A device that received this message determines, based on information included in the received message and shared information stored in the device, whether or not the message identifier included in the received message is proper, and determines whether or not the received message is proper. Accordingly, it is possible to increase the reliability of a message that is transmitted/received in the communication system, and as a result of assigning the message identifier in which shared information that is updated is used, it is possible to increase the resistance against retransmission attack.

### Advantageous Effects of Disclosure

According to the present disclosure, transmission/reception of a message using shared information whose value can change can be performed in the system configuration in which the relay device relays communication between a plurality of communication lines, by handling, as proper messages, both a message generated using shared information that is not yet updated and a message generated using updated shared information, during a period from update of shared information until a predetermined period elapses.

### BRIEF DESCRIPTION OF DRAWINGS

FIG. 1 is a block diagram showing the configuration of a communication system according to Embodiment 1.

FIG. 2 is a schematic diagram for illustrating the configuration of a message that is transmitted/received in the communication system according to Embodiment 1.

FIG. 3 is a schematic diagram for illustrating a problem caused by a difference in shared information.

FIG. 4 is a schematic diagram for illustrating a method for solving a problem caused by a difference in shared information.

FIG. 5 is a schematic diagram for illustrating the relationship between a toggle bit and whether or not a message can be relayed.

FIG. 6 is a block diagram showing the configuration of an ECU.

FIG. 7 is a block diagram showing the configuration of a gateway.

FIG. 8 is a flowchart showing a procedure of message transmission processing that is performed by an ECU.

FIG. 9 is a flowchart showing a procedure of message reception processing that is performed by an ECU.

FIG. 10 is a flowchart showing a procedure of processing for updating shared information that is performed by an ECU.

FIG. 11 is a flowchart showing a procedure of update processing that is performed by a gateway.

FIG. 12 is a flowchart showing a procedure of message relay processing that is performed by a gateway.

FIG. 13 is a flowchart showing a procedure of message relay processing that is performed by a gateway.

FIG. 14 is a block diagram showing the configuration of a communication system according to Embodiment 2.

FIG. 15 is a schematic diagram showing a first example of message transmission/reception and update of shared information that are performed by the communication system according to Embodiment 2.

FIG. 16 is a schematic diagram showing the first example of message transmission/reception and update of shared information that are performed by the communication system according to Embodiment 2.

FIG. 17 is a schematic diagram showing the first example of message transmission/reception and update of shared information that are performed by the communication system according to Embodiment 2.

FIG. 18 is a schematic diagram showing the first example of message transmission/reception and update of shared information that are performed by the communication system according to Embodiment 2.

FIG. 19 is a schematic diagram showing the first example of message transmission/reception and update of shared information that are performed by the communication system according to Embodiment 2.

FIG. 20 is a schematic diagram showing the first example of message transmission/reception and update of shared information that are performed by the communication system according to Embodiment 2.

FIG. 21 is a schematic diagram showing the first example of message transmission/reception and update of shared information that are performed by the communication system according to Embodiment 2.

FIG. 22 is a schematic diagram showing the first example of message transmission/reception and update of shared information that are performed by the communication system according to Embodiment 2.

FIG. 23 is a schematic diagram showing the first example of message transmission/reception and update of shared information that are performed by the communication system according to Embodiment 2.

### DETAILED DESCRIPTION OF PREFERRED EMBODIMENTS

### Embodiment 1

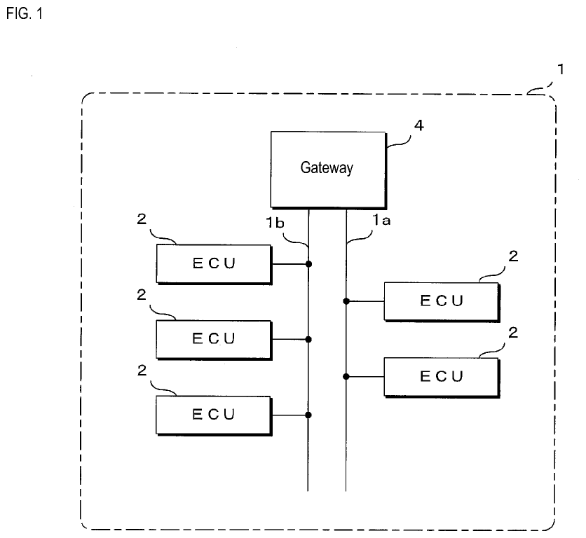

FIG. 1 is a block diagram showing the configuration of a communication system according to Embodiment 1. In the communication system according to this embodiment, a vehicle 1 is equipped with a plurality of ECUs (electronic control units) 2, which communicate with each other via communication lines 1a and 1b and a gateway 4 arranged in the vehicle 1. In the communication system according to this embodiment, the gateway 4 corresponds to a relay device, and the ECUs 2 correspond to communication devices. In the system configuration of the illustrated example, two ECUs 2 are connected to the in-vehicle communication line 1a, and three ECUs 2 are connected to the in-vehicle communication line 1b, with the two communication lines 1a and 1b being connected to the gateway 4, and the gateway 4 relays communication between the communication lines 1a and 1b, thereby enabling mutual transmission and reception of data between all ECUs 2.

The ECUs 2 may include various types of ECUs such as an ECU that controls the engine operation of the vehicle 1, an ECU that controls locking/unlocking of the doors, an ECU that controls on/off of the lighting, an ECU that controls the airbag operation, and an ECU that controls the ABS (antilock brake system) operation. Each ECU 2 is connected to the communication line 1a or 1b arranged in the vehicle 1, and is capable of transmitting data to and receiving data from the other ECUs 2 and the gateway 4 via the communication lines 1a and 1b.

The gateway 4 is connected with the communication lines 1a and 1b that constitute an in-vehicle network for the vehicle 1, and relays transmission/reception of data on these communication lines. In the example shown in FIG. 1, the gateway 4 is connected with two communication lines 1a and 1b, namely, the first communication line 1a to which two ECUs 2 are connected and the second communication line 1b to which three ECUs 2 are connected. The gateway 4 relays data by receiving data from one of the communication lines 1a and 1b and transmitting the received data to the other one of the communication lines 1a and 1b.

In the communication system according to this embodiment, the ECUs 2 and the gateway 4 perform communication in compliance with the CAN (Controller Area Network) communication protocol. Note that, the technique of a message identifier (MAC) is introduced in the CAN communication protocol that is adopted in the communication system according to this embodiment. A MAC is attached to a message that is transmitted by an ECU 2 and the gateway 4, and an ECU 2 and the gateway 4 that receive the message determine whether or not the MAC attached to the message is proper, thereby determining whether or not the received message is proper.

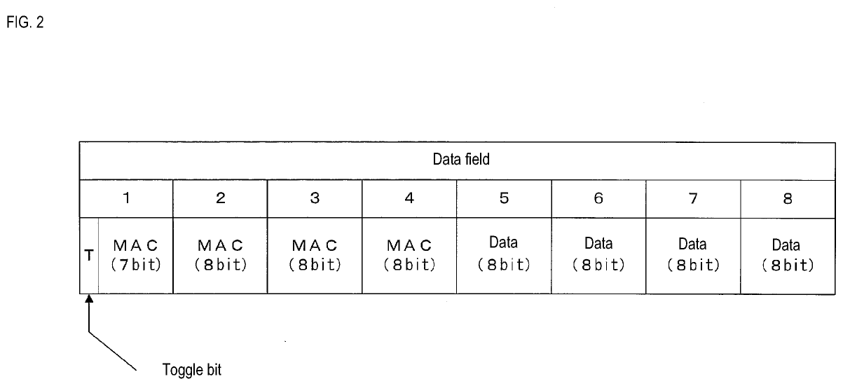

FIG. 2 is a schematic diagram for illustrating the configuration of a message that is transmitted/received in the communication system according to Embodiment 1. Note that FIG. 2 shows only a data field of eight bytes included in a message transmitted/received in compliance with the CAN communication protocol, and fields other than these such as an arbitration field and a control field are not illustrated. The data field of a message that is transmitted/received in compliance with the CAN communication protocol is constituted by a sequence of eight-byte (64 bit) binary information. In the data field of a message that is transmitted/received in the communication system according to Embodiment 1, the first 1 bit is a toggle bit, and the next 31 bits represent a MAC, followed by 32 bits that represent data.

The 32 bit data from the fifth byte to eighth byte represents information that is to be transmitted by an ECU 2 to another ECU 2, for example. A 31 bit MAC is generated based on the 32 bit data as well as an encryption key and shared information that are shared by the ECUs 2 and the gateway 4. The 1-bit toggle bit represents information used for processing for updating the shared information shared by the ECUs 2 and the gateway 4, and is a bit that is inverted between 0 and 1 every time update processing is performed. The ECU 2 generates a MAC based on information to be transmitted and the stored encryption key and shared information, and generates a data field in which a toggle bit and the MAC are appended to the data (information to be transmitted). The ECU 2 may generate other fields that constitute a message of the CAN communication protocol in accordance with a standard procedure of the CAN communication protocol.

The ECU 2 that has received the message determines, based on the value of the toggle bit of the data field included in the received message, whether or not processing for updating the shared information is being performed properly. If the processing for updating the shared information is being performed properly, the ECU 2 generates a MAC based on the encryption key and shared information stored in the ECU 2 itself and the 32 bit data included in the received message, and determines, based on whether or not the generated MAC and the MAC included in the received message match, whether or not the received message is proper.

In the communication system according to this embodiment, shared information of the ECUs 2 and the gateway 4 is updated at a predetermined timing. In this embodiment, the gateway 4 generates new shared update information at the predetermined timing, updates the shared information stored in the gateway 4 itself to the new shared information, and transmits the generated shared information to all ECUs 2 along with an update instruction. The ECUs 2 that receive the update instruction update shared information by replacing the shared information stored in the respective ECUs 2 with the new shared information attached to the update instruction. At this time, the gateway 4 transmits the update instruction to the two communication lines 1a and 1b at the same time, but, for example, if message collision or the like occurs on one of the communication lines 1a and 1b, there is a possibility that transmission of the update instruction is delayed on the communication line. If transmission of the update instruction is delayed, there is a time period during which the value of shared information is different between the ECUs 2 connected to the communication line 1a and the ECUs 2 connected to the communication line 1b.

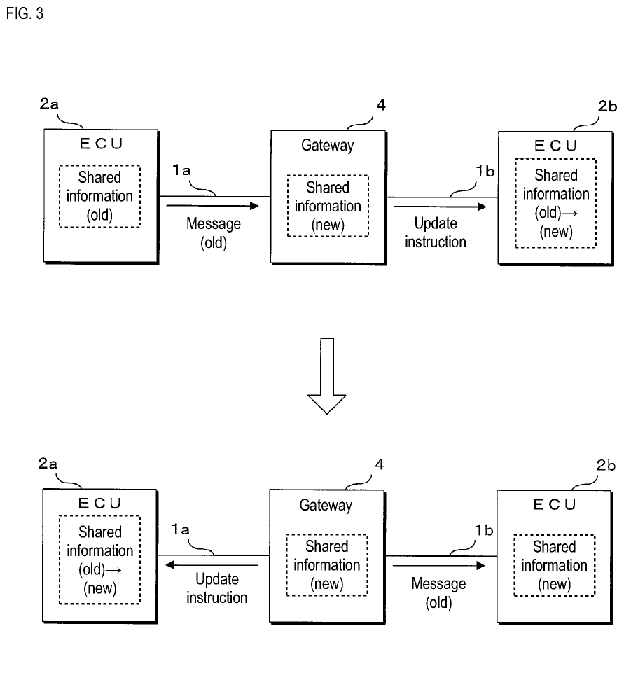

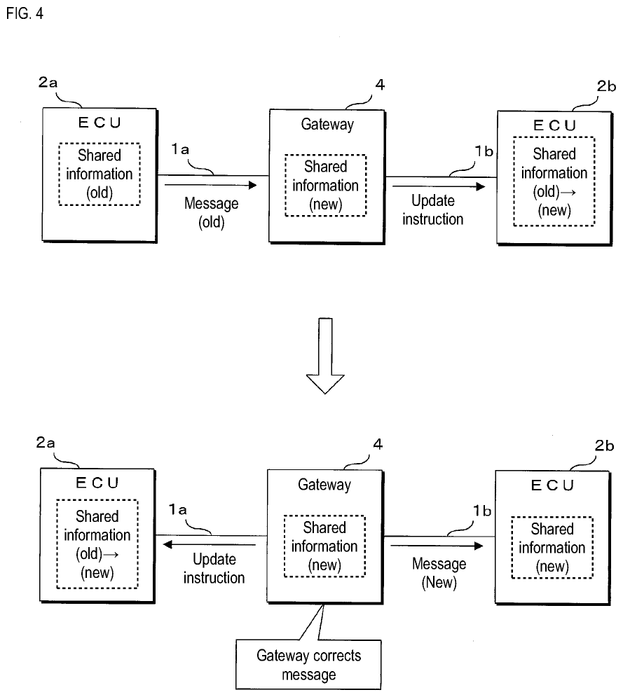

FIG. 3 is a schematic diagram for illustrating a problem that is caused by a difference in shared information. Note that, in FIGS. 3 and 4, an ECU 2 connected to the communication line 1a from among the plurality of ECUs 2 installed in the vehicle 1 is referred to as an ECU 2a, and an ECU 2 connected to the communication line 1b is referred to as an ECU 2b so as to distinguish these ECUs from each other. As shown in the upper portion in FIG. 3, the gateway 4 may generate new shared information (in FIG. 3, indicated as “shared information (new)”) to perform update, transmitting an update instruction to which the new shared information is attached, to the communication lines 1a and 1b at the same time. However, if an ECU 2a connected to the communication line 1a had transmitted a message slightly earlier than the transmission of an update instruction from the gateway 4, the gateway 4 cannot transmit the update instruction to the communication line 1a, and the transmission of the update instruction is delayed. A MAC generated using old shared information that is not yetthat is not yet updated (in FIG. 3, indicated as “shared information (old)”) is attached to the message transmitted by the ECU 2a at this time (in FIG. 3, such a message is indicated as “message (old)”). In addition, the ECU 2b connected to the communication line 1b that received the update instruction from the gateway 4 updates shared information by replacing old shared information that is stored in the gateway 4 itself with the new shared information attached to the update instruction (in FIG. 3, indicated as “shared information (old) to (new)”).

As shown in the lower portion in FIG. 3, after transmission of a message is completed by the ECU 2a, the gateway 4 transmits an update instruction to the communication line 1a. The ECU 2a that received the update instruction updates shared information, by replacing old shared information stored in the ECU 2a itself with the new shared information attached to the update instruction.

In addition, the gateway 4 relays the message by transmitting, to the communication line 1b, the message from the ECU 2a that has been received by the communication line 1a. However, the message that is relayed at this time is a message to which a MAC generated using old shared information that is not yet updated is attached. Therefore, the ECU 2b that receives this message determines that the MAC that has been generated using new shared information and is stored in the ECU 2b itself does not match the MAC attached to the received message, and that the received message is not a proper message.

Note that, in the example shown in FIG. 3, the gateway 4 that has received, from the ECU 2a, a message to which a MAC generated using old shared information that is not yet updated is attached relays this message to the ECU 2b, but this is a case where the gateway 4 does not determine whether or not the MAC is proper. If the gateway 4 determines whether or not the MAC of the message received from the ECU 2a, is proper, the message to which the MAC generated using old shared information that is not yet updated is attached is determined to not be a proper message by the gateway 4, and is not relayed to the ECU 2b. The result somewhat differs according to whether or not the gateway 4 performs determination regarding the MAC of the received message, but, in either case, the message to which a MAC generated using old shared information that is not yet updated is attached is determined to not be a proper message due to a difference in shared information.

FIG. 4 is a schematic diagram for illustrating a method for solving this problem, which occurs due to a difference in shared information. Note that the drawing in the upper portion in FIG. 4 is the same as that shown in the upper portion in FIG. 3. In the communication system according to this embodiment, if the gateway 4 receives, from the ECU 2a, a message to which a MAC generated using old shared information that is not yet updated is attached, due to a difference in shared information, the gateway 4 regards this message as a proper message and relays this message, during a period from update of shared information until a predetermined period elapses. Note that, if the gateway 4 simply relays the received message, the ECU 2b to which the message is relayed determines that this message is not a proper message, as shown in the lower portion in FIG. 3. In view of this, the gateway 4 according to this embodiment performs message correction by replacing a MAC that has been generated using old shared information that is not yet updated, and is attached to the received message, with a MAC generated using new shared information that has been updated, and is stored in the gateway 4 itself, and relays the corrected message to the ECU 2b.

Note that the predetermined period during which a message to which a MAC generated using old shared information that is not yet updated is attached and a message to which a MAC generated using new shared information that has been updated are accepted as proper messages by the gateway 4 is determined in advance when designing the communication system, or the like. For example, the predetermined period can be set to a maximum time period during which there is a possibility that an update instruction that is transmitted by the gateway 4 is delayed.

In addition, in order to perform the above-described processing, the gateway 4 is required to store two pieces of shared information, namely old shared information that is not yet updated (i.e. the shared information before the update) and new shared information that has been updated, at least for a period from the update of the shared information until a predetermined period elapses. In addition, the gateway 4 is required to determine which shared information was used to generate the MAC attached to the received message. For this reason, in the communication system according to this embodiment, a toggle bit is attached to a message as information for determining which shared information after or before the update was used for generating the MAC.

The toggle bit is a bit whose value is inverted every time update processing is performed. The value of the toggle bit is individually managed by each device included in the communication system. For example, if communication of the communication system is started with the toggle bit of 0 as an initial value, the ECUs 2 and the gateway 4 in the communication system generate messages whose toggle bit is set to 0, and transmit the messages. If, at a predetermined timing, the gateway 4 starts update processing, generates new shared information, and updates shared information of the gateway 4 itself, the toggle bit that is managed by the gateway 4 changes to 1. After that, the gateway 4 transmits an update instruction, and any ECU 2 that receives this update instruction updates its own shared information, and changes the toggle bit that is managed by the ECU 2 itself to 1.

Thus, for example, if the value of the toggle bit that is managed by the gateway 4 is 1 while the value of the toggle bit attached to a received message is 0, the gateway 4 can determine that there is a possibility that a MAC generated using old shared information that is not yet updated is attached to this message. In view of this, the gateway 4 determines whether or not the MAC attached to the received message using old shared information that is not yet updated is proper, and if the MAC is proper, performs the above-described message correction. Accordingly, if the value of the toggle bit that is managed by the gateway 4 matches the value of the toggle bit attached to the received message, the gateway 4 can determine that the MAC attached to the received message has been generated using new shared information that has been updated, and if the value of the toggle bit does not match the value of the toggle bit attached to the received message, can determine that the MAC attached to the received message has been generated using old shared information that is not yet updated.

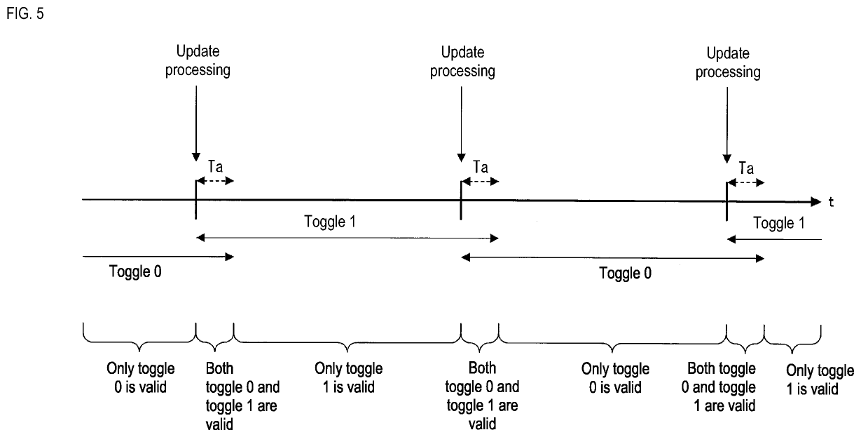

FIG. 5 is a schematic diagram for illustrating the relationship between a toggle bit and whether or not a message can be relayed. Basically, if the value of the toggle bit that is managed by the gateway 4 is 0, the gateway 4 performs relay processing such that only a message in which the value of the toggle bit is 0 is regarded as a valid message, and if the value of the toggle bit that is managed by the gateway 4 is 1, performs relay processing such that only a message in which the value of the toggle bit is 1 is regarded as a valid message. Note that, during a period from update processing until a predetermined period Ta elapses, the gateway 4 performs relay processing regardless of the value of the toggle bit that is managed by the gateway 4 itself, such that both a message in which the value of the toggle bit is 0 and a message in which the value of the toggle bit is 1 are regarded as valid messages. Note that, if, during the period from the update processing until the predetermined period Ta elapses, the gateway 4 receives a message to which a toggle bit the value of which is different from the value of toggle bit that is managed by the gateway 4 itself is attached, the gateway 4 corrects the values of the toggle bit and the MAC of the received message, and then relays the message.

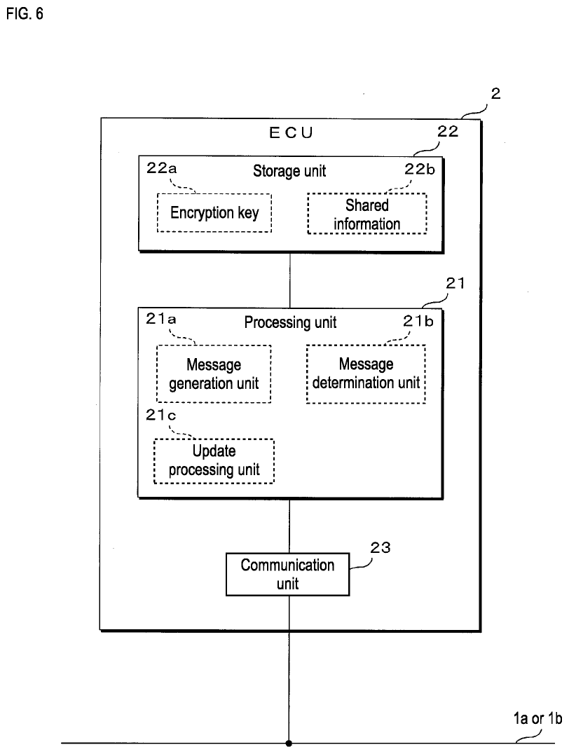

FIG. 6 is a block diagram showing the configuration of an ECU 2. Note that, in FIG. 6, only functional blocks that are common to the ECUs 2 are shown, and functional blocks different according to each ECU 2 are not illustrated. An ECU 2 according to this embodiment includes a processing unit 21, a storage unit 22, a communication unit 23, and the like. The processing unit 21 is configured using an arithmetic processing device such as a CPU (central processing unit) or an MPU (micro-processing unit), and performs various types of calculation processing by reading out and executing programs stored in the storage unit 22, a ROM (read only memory, not illustrated), or the like. Note that contents of programs that are executed by the processing unit 21 are different for the ECUs 2.

The storage unit 22 is configured using a nonvolatile memory element such as a flash memory or an EEPROM (electrically erasable programmable read only memory). In this embodiment, the storage unit 22 stores an encryption key 22a and shared information 22b as information for generating a MAC to be attached to a message that is to be transmitted. The encryption key 22a is information for performing encryption and decryption through a common key system, for example, and is information shared by all of the ECUs 2 and the gateway 4 included in the communication system. Similarly, the shared information 22b is also information shared by all of the ECUs 2 and the gateway 4 included in the communication system, but the shared information 22b is information that is relatively frequently updated.

The communication unit 23 is connected to the communication line 1a or 1b that constitutes an in-vehicle network, and transmits/receives data in compliance with the CAN communication protocol. The communication unit 23 converts data given by the processing unit 21 into electrical signals and outputs the electrical signals to the communication line 1a or 1b, and thereby transmits the data, and receives data by sampling and acquiring the potential of the communication line 1a or 1b, and sends the received data to the processing unit 21.

In addition, in the processing unit 21 of an ECU 2 according to this embodiment, as a result of executing programs stored in the storage unit 22, the ROM, or the like, a message generation unit 21a, a message determination unit 21b, an update processing unit 21c, and the like are realized as software-like functional blocks. If there is information that is to be transmitted to another ECU 2, the message generation unit 21a generates a MAC by performing predetermined encryption calculation using this information, and the encryption key 22a and the shared information 22b stored in the storage unit 22. The message generation unit 21a generates a data field that includes the value of the toggle bit that is managed by the ECU to which the message generation unit 21a belongs to, the generated MAC, and information (data) to be transmitted to another ECU 2, and combines the generated data field with an arbitration field, a control field, and the like, and thereby generates a message that is to be transmitted. By sending the message generated by the message generation unit 21a to the communication unit 23, this message is transmitted to the communication lines 1a and 1b, and is received by another ECU 2. Note that the value of the toggle bit is stored in the storage unit 22, for example, and the value is inverted every time the shared information 22b is updated.

The message determination unit 21b determines whether or not a message received by the communication unit 23 is a proper message. The message determination unit 21b generates a MAC for checking, by performing a predetermined encryption calculation using data included in the received message and the encryption key 22a and the shared information 22b that are stored in the storage unit 22. Note that the encryption calculation that is performed by the message generation unit 21a and the encryption calculation that is performed by the message determination unit 21b are the same processes. The message determination unit 21b compares the MAC included in the received message with the MAC generated by the message determination unit 21b itself, and if those MACs match, determines that the received message is proper and if those MACs do not match, determines that the received message is not proper. Note that, in this embodiment, the message determination unit 21b of each ECU 2 does not use the toggle bit included in the received message.

When an update instruction that is transmitted by the gateway 4 is received by the communication unit 23, the update processing unit 21c updates the shared information 22b stored in the storage unit 22. For example, the update instruction that is transmitted by the gateway 4 can be a message in which new shared information is stored as data in the data field, and to which a MAC generated using old shared information that is not yet updated is attached. When the communication unit 23 receives the update instruction, the message determination unit 21b determines whether or not the received update instruction is a proper update instruction, similar to a normal message. If it is determined that the received update instruction is a proper update instruction, the update processing unit 21c updates the shared information by overwriting the shared information 22b stored in the storage unit 22 with new shared information included in the update instruction.

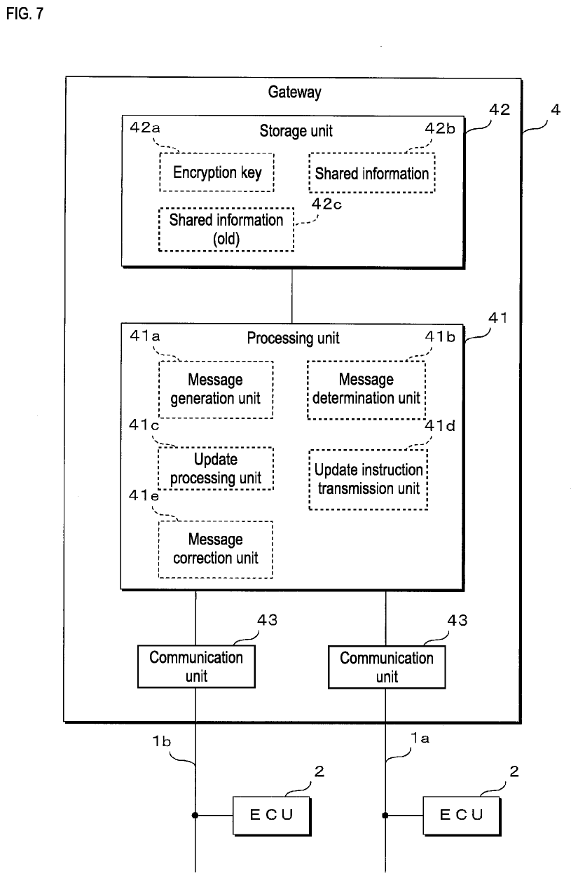

FIG. 7 is a block diagram showing the configuration of the gateway 4. The gateway 4 according to this embodiment includes a processing unit 41, a storage unit 42, two communication units 43, and the like. The processing unit 41 is configured using an arithmetic processing device such as a CPU or an MPU, and performs various types of calculation processing by reading out and executing programs stored in the storage unit 42, the ROM (not illustrated), or the like. In this embodiment, the processing unit 41 performs calculation processing necessary for processing for relaying message transmission/reception between the communication lines 1a and 1b in the in-vehicle network, processing for updating shared information, and the like.

The storage unit 42 is configured using a nonvolatile memory element such as a flash memory or an EEPROM. The storage unit 42 stores an encryption key 42a and shared information 42b that are similar to the encryption key 22a and the shared information 22b stored in the storage unit 22 of each ECU 2. In addition, in this embodiment, the storage unit 42 of the gateway 4 stores old shared information 42c that is not yet updated as well as the shared information 42b that is currently used for message transmission/reception. In addition, the storage unit 42 may store a program that is executed by the processing unit 41, data required for executing this program, data generated in the process of processing of the processing unit 41, and the like.

The two communication units 43 are respectively connected to the communication lines 1a and 1b that constitute the in-vehicle network, and transmit/receive data in compliance with the CAN communication protocol. The communication units 43 transmit information by converting, into electrical signals, data given from the processing unit 41, and outputting the electrical signals to the communication lines 1a and 1b, and receive data by sampling and acquiring the potential of the communication lines 1a and 1b, and send the received data to the processing unit 41.

In addition, in the processing unit 41, a message generation unit 41a, a message determination unit 41b, an update processing unit 41c, an update instruction transmission unit 41d, a message correction unit 41e, and the like are realized as software-like functional blocks as a result of executing programs stored in the storage unit 42, the ROM, or the like. The processing that is performed by the message generation unit 41a is substantially the same as the processing that is performed by the message generation unit 21a of each ECU 2. Accordingly, if there is information to be transmitted to another device, the message generation unit 41a generates a MAC by performing predetermined encryption calculation using this information, and the encryption key 42a and the shared information 42b that are stored in the storage unit 42. The message generation unit 41a generates a message to be transmitted, by generating a data field that includes the value of the toggle bit that is managed by the message generation unit 41a itself, the generated MAC, and information (data) to be transmitted to another device, and coupling the generated data field with an arbitration field, a control field, and the like. By sending the message generated by the message generation unit 41a to the communication units 43, this message is transmitted to the communication lines 1a and 1b, and is received by the ECUs 2 connected to these communication lines 1a and 1b. Note that the value of the toggle bit is stored in the storage unit 42, for example, and the value is inverted every time the shared information 42b is updated.

The processing that is performed by the message determination unit 41b is substantially the same as the processing that is performed by the message determination unit 21b of each ECU 2. Accordingly, the message determination unit 41b determines whether or not a message received by the communication units 43 is a proper message. The message determination unit 41b generates a MAC for checking, by performing predetermined encryption calculation using data included in the received message, the encryption key 42a stored in the storage unit 42, and the shared information 42b or 42c. The message determination unit 41b compares the MAC included in the received message with the MAC generated by the message determination unit 41b itself, and if those MACs match, determines that the received message is a proper message, and if those MACs do not match, determines that the received message is not a proper message.

In addition, in this embodiment, as described above, during a period from update of the shared information 42b until a predetermined period elapses, the gateway 4 also accepts, as a proper message, any message to which a MAC generated using old shared information that is not yet updated is attached. Therefore, during a period from update of the shared information 42b until a predetermined period elapses, the message determination unit 41b of the gateway 4 determines, according to the value of the toggle bit included in the received message, whether the new shared information 42b that has been updated or the old shared information 42c that is not yet updated, which are stored in the storage unit 42, is to be used to generate a MAC for checking. Accordingly, if the value of the toggle bit included in the received message matches the value of the toggle bit stored in the storage unit 42, the message determination unit 41b generates a MAC for checking, using the new shared information 42b that has been updated and is stored in the storage unit 42, and determines whether or not the received message is proper. On the other hand, if the value of the toggle bit included in the received message does not match the value of the toggle bit stored in the storage unit 42, the message determination unit 41b generates a MAC for checking, using the old shared information 42c that has not been updated, and is stored in the storage unit 42, and determines whether or not the received message is proper. Note that, after a predetermined period has elapsed since update of the shared information 42b, if the value of toggle bis included in the received message does not match the value of the toggle bit stored in the storage unit 42, the message determination unit 41b may determine that this received message is not a proper message.

The update processing unit 41c determines whether or not a timing for updating shared information of the ECUs 2 and the gateway 4 included in the communication system has come. For example, a configuration may be adopted in which the update processing unit 41c determines that the timing for update has come when a predetermined cycle such as one second, one minute, one hour, one day, one week, or the like elapsed since the last update processing, and, for example, a configuration may also be adopted in which it is determined that the timing for update has come when an ignition switch of the vehicle 1 is switched from an off state to an on state, and a configuration may also be adopted in which a timing other than this timing is determined as an update timing.

If it is determined that the timing for performing update processing has come, the update processing unit 41c generates new shared information. For example, the update processing unit 41c generates a random number based on a predetermined random number generating algorithm, and generates shared information based on this random number. The update processing unit 41c updates the shared information 42b by setting the new shared information 42b stored in the storage unit 42 as the old shared information 42c, and storing the generated shared information as the new shared information 42b in the storage unit 42.

When the update processing unit 41c performs update processing of the device to which the update processing unit 41c belongs, the update instruction transmission unit 41d transmits, from the communication units 43, an update instruction for causing the ECUs 2 connected to the communication lines 1a and 1b to perform update processing. The update instruction transmission unit 41d transmits an update instruction from the two communication units 43 to all of the ECUs 2 at the same time, such that new shared information generated by the update processing unit 41c serves as data, and a message to which a MAC generated using the old shared information 42c that has not been updated and that is stored in the storage unit 42 is attached serves as the update instruction.

During a period from update of shared information until a predetermined period elapses, the message correction unit 41e receives a message in which the value of the toggle bit does not match the value of the toggle bit stored in the storage unit 42, and if the message determination unit 41b determines that this received message is a proper message, corrects the toggle bit and the MAC of the received message. At this time, the message correction unit 41e inverts the value of the toggle bit included in the received message. In addition, the message correction unit 41e generates a new MAC based on data included in the received message, the encryption key 22a stored in the storage unit 42, and the new shared information 22b that has been updated, and replaces the MAC included in the received message with the newly generated MAC, and thereby corrects the received message. The message corrected by the message correction unit 41e is transmitted from the communication unit 43 other than the communication unit 43 that received the original message, and is relayed to the ECUs 2.

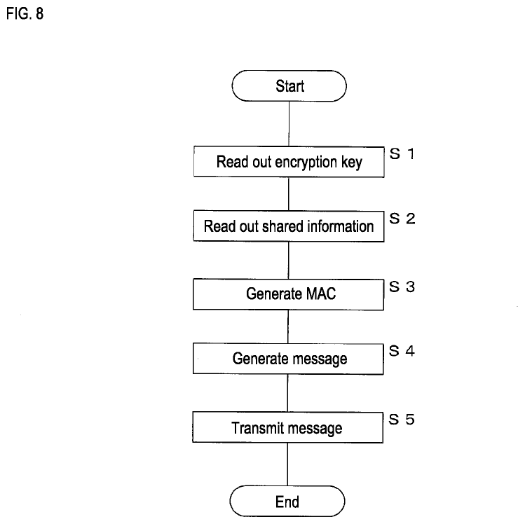

FIG. 8 is a flowchart showing a procedure of message transmission processing that is performed by an ECU 2. The processing unit 21 of the ECU 2 starts the following message transmission processing when it is necessary to transmit information to another ECU 2. The message generation unit 21a of the processing unit 21 reads out the encryption key 22a stored in the storage unit 22 (step S1), and reads out the shared information 22b stored in the storage unit 22 (step S2). The message generation unit 21a generates a MAC using information to be transmitted to another ECU 2, the encryption key 22a read out in step S1, and the shared information 22b read out in step S2 (step S3). The message generation unit 21a generate a message that includes the toggle bit stored in the storage unit 22, the MAC generated in step S3, and information that is to be transmitted to another ECU 2 (step S4). The processing unit 21 sends the message generated by the message generation unit 21a, to the communication unit 23, and thereby transmits the message to another ECU 2 (step S5), and ends the processing.

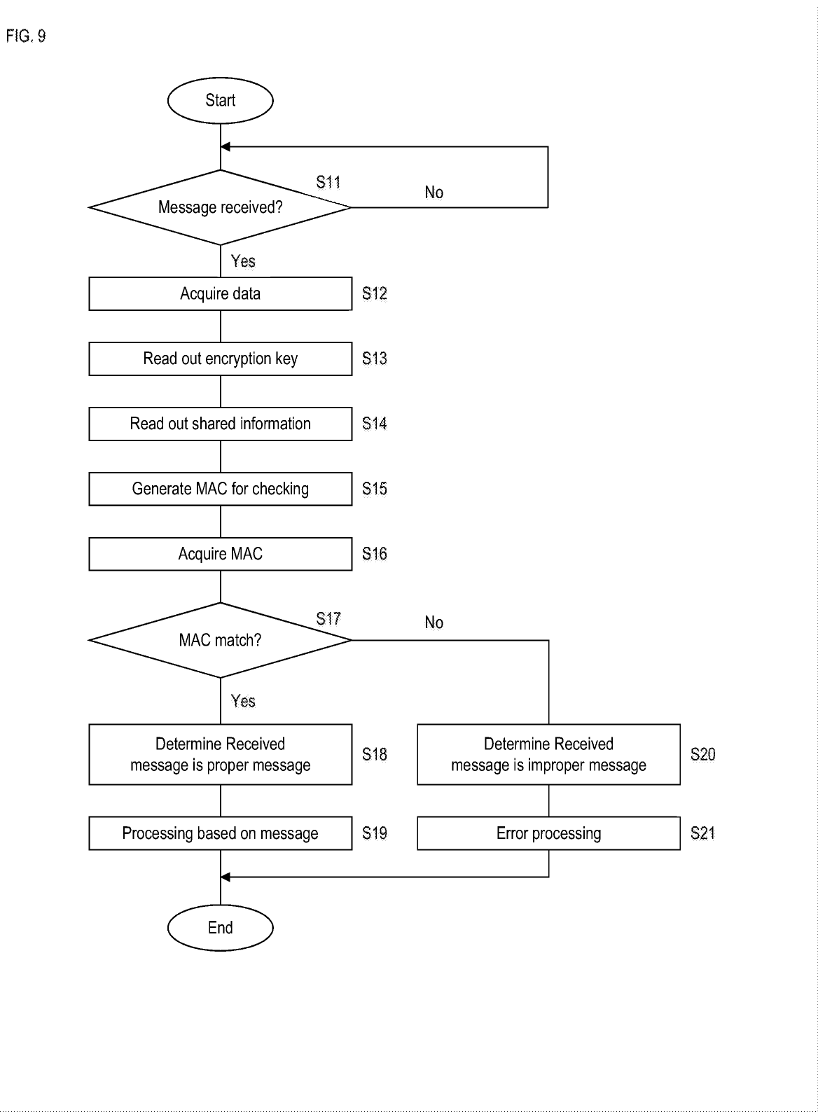

FIG. 9 is a flowchart showing a procedure of message reception processing that is performed by an ECU 2. The processing unit 21 of the ECU 2 determines whether or not the communication unit 23 has received a message from another ECU 2 or the gateway 4 (step S11). If no message has been received (S11: NO), the processing unit 21 waits until a message is received. If a message is received (S11: YES), the message determination unit 21b of the processing unit 21 acquires data included in the received message (step S12). The message determination unit 21b reads out the encryption key 22a stored in the storage unit 22 (step S13), and reads out the shared information 22b stored in the storage unit 22 (step S14). The message determination unit 21b generates a MAC for checking, using data acquired in step S12, the encryption key 22a that has been read out in step S13, and the shared information 22b that has been read out in step S14 (step S15). In addition, the message determination unit 21b acquires the MAC included in the received message (step S16).

The message determination unit 21b determines whether or not the MAC for checking generated in step S15 and the MAC acquired in step S16 match (step S17). If those MACs match (S17: YES), the message determination unit 21b determines that the received message is a proper message (step S18). The processing unit 21 performs appropriate processing that is based on the content of data included in the received message (step S19), and ends the message reception processing. On the other hand, if those MACs do not match (S17: NO), the message determination unit 21b determines that the received message is an improper message (step S20). The processing unit 21 performs error processing and the like (step S21), and ends message reception processing.

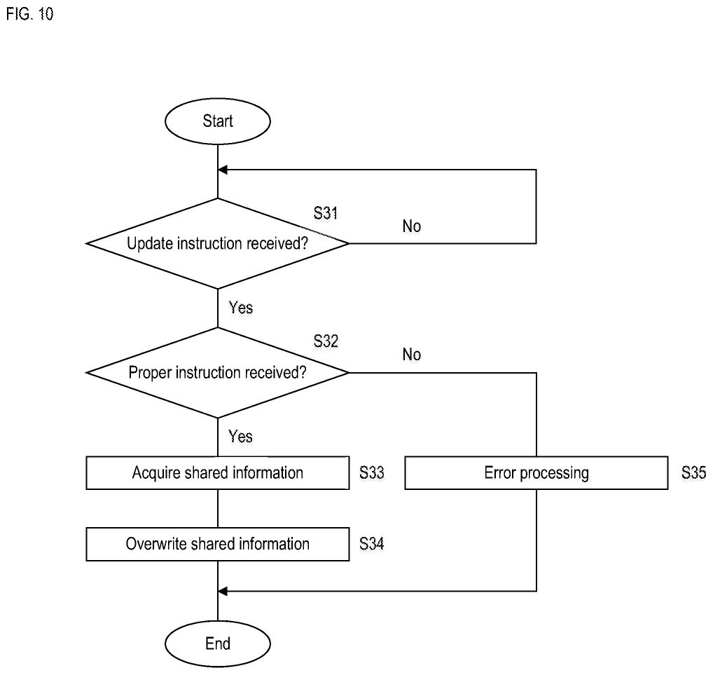

FIG. 10 is a flowchart showing a procedure of processing for updating shared information that is performed by an ECU 2. The processing unit 21 of the ECU 2 determines whether or not the communication unit 23 has received an update instruction from the gateway 4 (step S31). If no update instruction has been received (S31: NO), the processing unit 21 waits until an update instruction is received. If an update instruction has been received (S31: YES), the processing unit 21 determines whether or not the received update instruction is a proper update instruction (step S32). Note that the determination on whether or not the update instruction is a proper update instruction is performed through processing that is similar to the determination on whether or not a received message is a proper message, which is shown in message reception processing in FIG. 9, and thus a detailed description thereof is omitted.

If the received update instruction is a proper update instruction (S32: YES), the update processing unit 21c of the processing unit 21 acquires shared information included in the update instruction (step S33). The update processing unit 21c performs update by overwriting the shared information 22b stored in the storage unit 22 with the acquired shared information (step S34), and ends update processing. If the received update instruction is not a proper update instruction (S32: NO), the processing unit 21 performs error processing and the like (step S35), and ends the update processing without updating the shared information 22b.

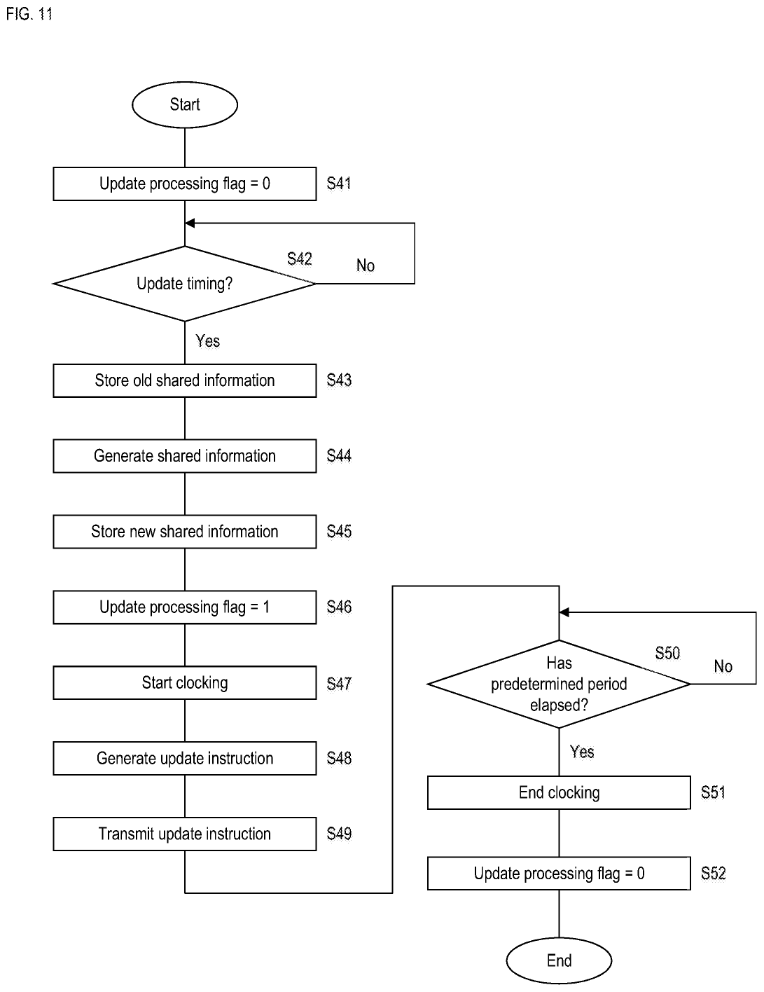

FIG. 11 is a flowchart showing a procedure of update processing that is performed by the gateway 4. Note that, this processing is performed using a “update processing flag” that holds value of 0 or 1, but this flag can be realized using a storage region such as a register of the processing unit 41, for example. During a period from update of shared information until a predetermined period elapses, the value of the update processing flag is set to 1, and, during a period other than that, it is set to 0. First, the update processing unit 41c of the processing unit 41 of the gateway 4 initializes the value of the update processing flag to 0 (step S41). The update processing unit 41c determines whether or not a predetermined timing for performing update processing has come (step S42). If the timing for performing update processing has not been reached (S42: NO), the update processing unit 41c waits until the timing for performing update processing is reached.

When the timing for performing update processing is reached (S42: YES), the update processing unit 41c stores, in the storage unit 42, the shared information 42b of the storage unit 42 that is used at that point, as the old shared information 42c that is not yet updated (step S43). The update processing unit 41c generates new shared information, for example, through a method for generating a random number or the like (step S44). The update processing unit 41c stores, in the storage unit 42, the generated shared information as the new shared information 42b that has been updated (step S45). Note that, at this time, the update processing unit 41c inverts the value of the toggle bit stored in the storage unit 42.

Next, the processing unit 41 sets the value of the update processing flag to 1 (step S46). The processing unit 41 starts clocking of a predetermined period from update of shared information, using its own a timer function, or the like (step S47). The update instruction transmission unit 41d of the processing unit 41 generates an update instruction that includes the new shared information generated in step S44 (step S48). The update instruction transmission unit 41d transmits the generated update instruction to all of the communication units 43 (step S49).

After that, the processing unit 41 determines whether or not a predetermined period has elapsed since the start of clocking in step S47 (step S50). If the predetermined period has not elapsed (S50: NO), the processing unit 41 waits until the predetermined period elapses. When the predetermined period has elapsed (S50: YES), the processing unit 41 ends clocking of the predetermined period (step S51). The processing unit 41 sets the value of the update processing flag to 0 (step S52), and ends the update processing.

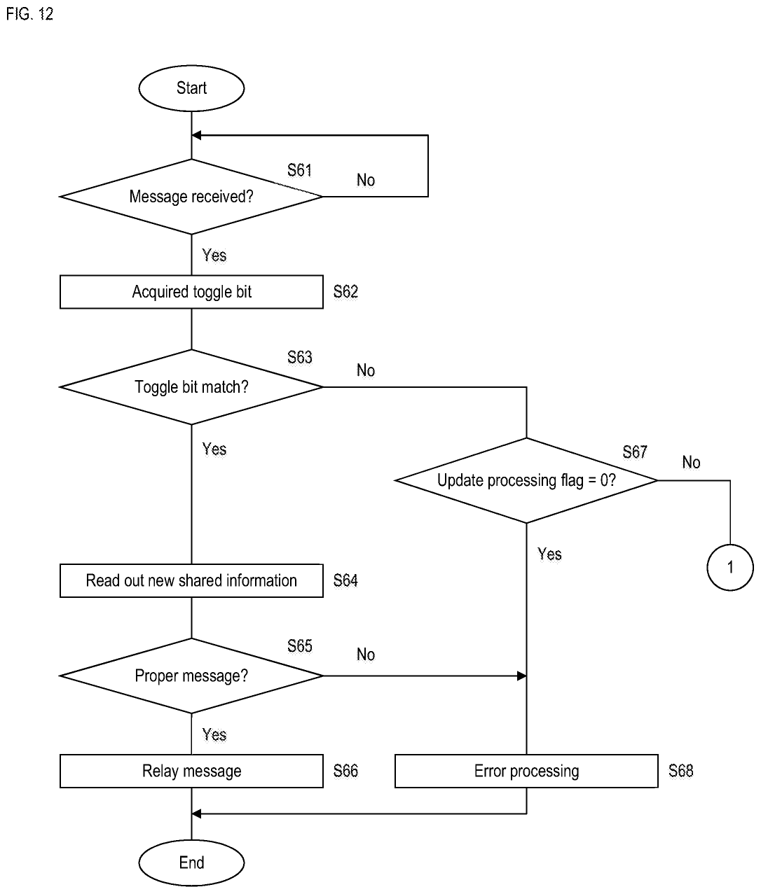

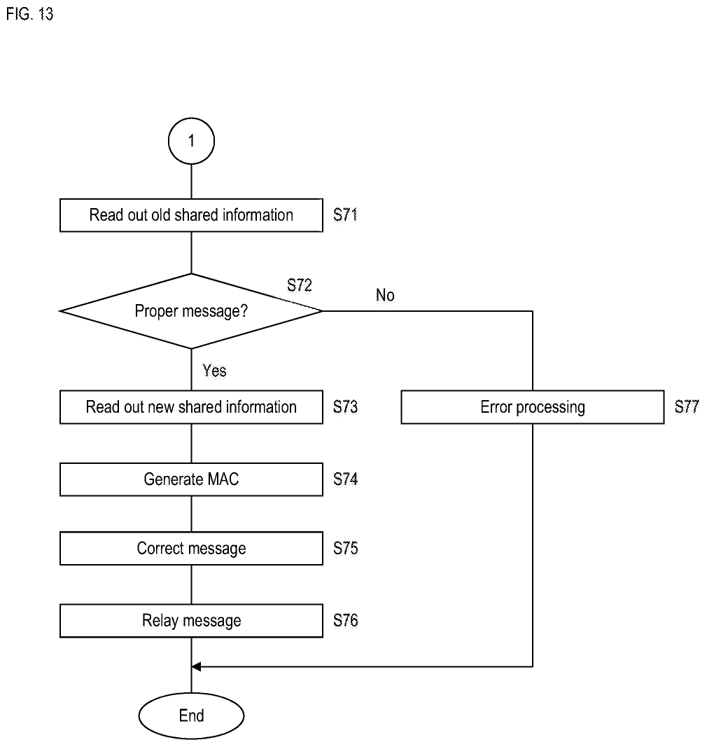

FIGS. 12 and 13 are flowcharts showing a procedure of message relay processing that is performed by the gateway 4. Note that an update processing flag that is used in this processing is the same as the update processing flag used in update processing in FIG. 11. The processing unit 41 of the gateway 4 determines whether or not any of the communication units 43 has received a message (step S61). If no message has been received (S61: NO), the processing unit 41 waits until a message is received.

If any of the communication units 43 has received the message (S61: YES), the message determination unit 41b of the processing unit 41 acquires the value of the toggle bit included in the received message (step S62). The message determination unit 41b compares the value of the toggle bit acquired in step S62 with the value of the toggle bit stored in the storage unit 42, and determines whether or not those toggle bits match (step S63). If those toggle bits match (S63: YES), the MAC attached to this received message is a message generated using new shared information that has been updated, and thus the message determination unit 41b reads out the new shared information 42b that has been updated and is stored in the storage unit 42 (step S64). The message determination unit 41b determines, based on the new shared information 42b that has been updated and has been read out in step S64, whether or not the received message is a proper message (step S65). If it is determined that the received message is a proper message (S65: YES), the processing unit 41 transmits the received message to a communication unit 43 other than the communication unit 43 that has received the message, thereby relays the message (step S66), and ends the relay processing. If it is determined that the received message is not a proper message (S65: NO), the processing unit 41 performs error processing or the like (step S68), and ends relay processing without relaying the message.

If the toggle bits do not match (S63: NO), the message determination unit 41b determines whether or not the value of the update processing flag is 0 (step S67). If the value of the update processing flag is 0 (S67: YES), a MAC generated using new shared information that has been updated is not attached to this received message, and a predetermined period has not elapsed from update of shared information, and thus the processing unit 41 determines that the received message is not a proper message, performs error processing and the like (step S68), and ends relay processing without relaying the message.

If the value of the update processing flag is not 0 (S67: NO), in other words if the value of the update processing flag is 1, the MAC attached to this received message is a MAC generated using old shared information that is not yet updated, and thus the message determination unit 41b reads out the old shared information 42c that has not been updated and is stored in the storage unit 42 (step S71). The message determination unit 41b determines whether or not the received message is a proper message, based on the old shared information 42c that has not been updated and has been read out in step S71 (step S72).

If it is determined that the received message is a proper message (S72: YES), the message correction unit 41e of the processing unit 41 reads out the new shared information 42b that has been updated and is stored in the storage unit 42 (step S73). The message correction unit 41e generates a new MAC based on data included in the received message and the encryption key 22a stored in the storage unit 42 using the new shared information 42b that has been updated and has been read out in step S73 (step S74). The message correction unit 41e corrects the message by reversing the toggle bit of the received message, and replacing the MAC in the received message with the MAC generated in step S74 (step S75). The processing unit 41 transmits the message corrected in step S75, to a communication unit 43 other than the communication unit 43 that received the message, thereby relaying the message (step S76), and ends the relay processing. In addition, if it is determined that the received message is not a proper message (S72: NO), the processing unit 41 performs error processing and the like (step S77), and ends the relay processing without relaying the message.

The communication system according to this embodiment having the above-described configuration is configured such that a plurality of ECUs 2 are connected to each of the communication lines 1a and 1b, such communication lines 1a and 1b are connected to the gateway 4, and the gateway 4 relays communication between the communication lines 1a and 1b. The ECUs 2 and the gateway 4 included in the communication system store shared information, perform generation and transmission of a message to another device and determination on whether or not a message received from another device is proper, using the stored shared information. The shared information stored in the ECUs 2 and the gateway 4 is variable information, and is updated in accordance with an update instruction that is transmitted by the gateway 4. Accordingly, the update instruction transmitted by the gateway 4 is received by the ECUs 2 via the communication lines 1a and 1b, and an ECU 2 that received the update instruction updates shared information stored in the ECU 2 itself. Note that shared information may be updated periodically in a predetermined period such as one second, one minute, one hour, one day, or a week, and, may be updated every time a certain event occurs, for example, every time an ignition switch of the vehicle 1 is switched from an off state to an on state.

There is a possibility that collisions, delays, and the like of the update instruction that is transmitted by the gateway 4 occur during transmission, relay between the communication lines 1a and 1b, or the like. In view of this, during a period from the timing for updating shared information until when a predetermined period elapses, the gateway 4 of the communication system according to this embodiment handles, as proper messages, both a message generated using old shared information that is not yet updated and a message generated using new shared information that has been updated, and relays these messages. Note that, for example, the timing for updating shared information, which is a start point of the predetermined period, can be a timing when the shared information 42b stored in the storage unit 42 (of the gateway 4) was updated, a timing when an update instruction was transmitted to the ECUs 2, or the like.

Accordingly, in the communication system according to this embodiment, during a certain period from when an update instruction transmitted by the gateway 4 is received by all of the ECUs 2 until update processing is performed, a message generated using old shared information that is not yet updated and a message generated using new shared information that has been updated can be transmitted/received. Thus, even in a communication system having a configuration in which the gateway 4 relays communication between a plurality of communication lines 1a and 1b, it is possible to realize message transmission/reception in which shared information whose value changes is used.

In addition, if a message generated using old shared information that is not yet updated is received during a period from update of shared information until a predetermined period elapses, the gateway 4 according to this embodiment corrects this message to a message in which new shared information that has been updated is used, and relays the corrected message. Accordingly, the ECUs 2 to which the message is relayed (the relay destinations) can receive the message generated using new shared information that has been updated.

In addition, in the communication system according to this embodiment, a toggle bit is included in a message as update state information indicating the update state of shared information. Accordingly, the gateway 4 can easily determine whether the received message is a message in which old shared information that is not yet updated is used or a message in which new shared information that has been updated is used.

In addition, an ECU 2 generates a MAC based on data that is to be transmitted, and the encryption key 22a and the shared information 22b that are stored in the storage unit 22, and transmits a message including this MAC to another ECU 2. The ECU 2 that received the message generates a MAC for checking, based on data included in the received message and the encryption key 22a and the shared information 22b stored in the storage unit 22, and compares the MAC for checking with the MAC included in the received message, and thereby determines whether or not the received message is proper. Accordingly, it is possible to increase the reliability of a message that is transmitted/received in the communication system, and by assigning a MAC in which shared information that is updated is used, it is possible to increase the resistance against retransmission attack.

Note that, in this embodiment, a configuration is adopted in which the gateway 4 performs generation of shared information, transmission of an update instruction, and the like, but there is no limitation thereto, and a configuration may be adopted in which one of the ECUs 2 included in the communication system performs generation of shared information, transmission of an update instruction, and the like. In addition, a configuration is adopted in which new shared information is transmitted from the gateway 4 to the ECUs 2 in order to update shared information, but there is no limitation thereto. For example, a configuration may be adopted in which all of the ECUs 2 and the gateway 4 generate shared information in accordance with the same rule, such as a configuration in which shared information is the value of a counter, and upon receiving an update instruction, the ECU 2 increases/decreases the value of the counter.

In addition, in this embodiment, a configuration is adopted in which a message to which a MAC is attached is transmitted/received, but there is no limitation thereto, and, for example, a configuration may also be adopted in which an ECU 2 transmits/receives a message in which a toggle bit has been appended to encrypted information that is to be transmitted. In addition, the update state information that is attached to a message does not need to be a toggle bit, and may be information in which the value changes in accordance with a certain rule such as a counter value that increases/decreases every time update processing is performed. Furthermore, a configuration may also be adopted in which update state information such as a toggle bit is not attached to a message, and, in this case, a configuration can be adopted in which the gateway 4 performs, during a period from update of shared information until a predetermined period elapses, on a received message, both determination on whether no not a message in which new shared information that has been updated is used is proper and determination on whether no not a message in which old shared information that is not yet updated is used is proper.

In addition, the communication system according to this embodiment is a system that is installed in the vehicle 1, but is not limited thereto, and may be a communication system other than an in-vehicle system. In addition, the communication devices may be various devices that have a communication function other than the ECUs 2, and the relay device may be various devices that have a relay function other than the gateway 4.

### Modified Example

In the foregoing, a configuration is adopted in which, during a period from update of shared information until a predetermined period elapses, the gateway 4 handles, as valid messages, a message in which old shared information that is not yet updated is used and a message in which new shared information that has been updated is used, but there is no limitation thereto.

In a communication system according to Modified Example, during a period from update of shared information until a predetermined period elapses, the ECUs 2 receive, as a valid massage, a message in which old shared information that is not yet updated is used and a message in which new shared information that has been updated. In this case, a configuration may be adopted in which the gateway 4 relays this message without determining whether or not the received message is proper, or a configuration may also be adopted in which, during a period from update of shared information until a predetermined period elapses, the gateway 4 receives, as a valid message, a message in which old shared information that is not yet updated is used and a message in which new shared information that has been updated is used, and relays the message without correcting the message.

### Embodiment 2

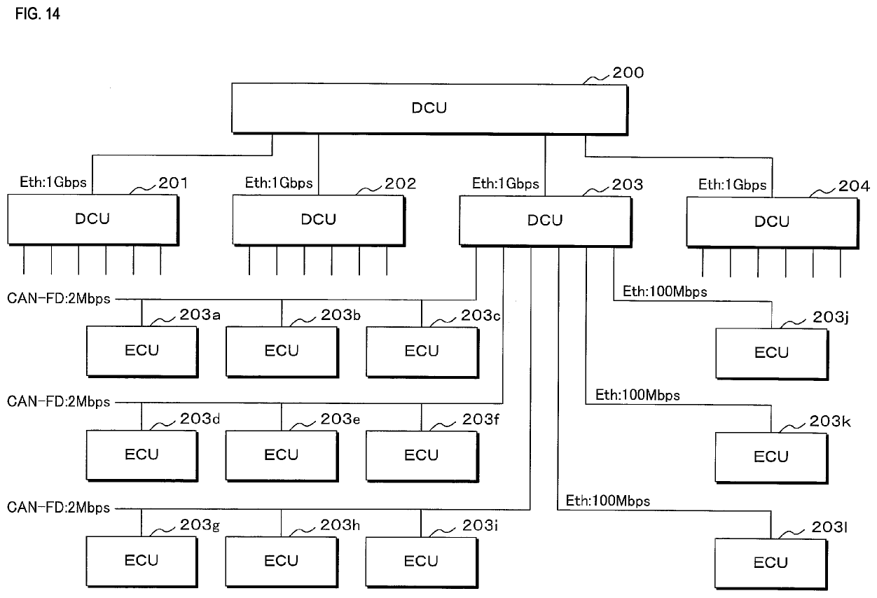

A communication system according to Embodiment 2 has a configuration in which there are a plurality of communication protocols and a plurality of relay devices are connected in a layered manner. FIG. 14 is a block diagram showing the configuration of the communication system according to Embodiment 2. The communication system according to Embodiment 2 includes a plurality of DCUs (domain control unit) 200 to 204 as relay devices and a plurality of ECUs 203a to 203l as communication devices. In the communication system according to Embodiment 2, there are a network in which communication is performed at a communication speed of 1 Gbps in compliance with the Ethernet (registered trademark) communication protocol, a network in which communication is performed at a communication speed of 100 Mbps in compliance with the Ethernet (registered trademark) communication protocol, and a network in which communication is performed at a communication speed of 2 Mbps in compliance with the CAN-FD communication protocol.

The communication system according to Embodiment 2 has a layered structure in which the four DCUs 201 to 204 are connected to one DCU 200, and a plurality of ECUs are connected to each of the DCUs 201 to 204. The one DCU 200 and the four DCUs 201 to 204 are connected via respective communication lines, and perform communication at a communication speed of 1 Gbps in compliance with the Ethernet (registered trademark) communication protocol. In addition, six communication lines for connecting one or more ECUs are connectable to each of the four DCUs 201 to 204 of the communication system according to Embodiment 2, in addition to the communication lines connected to the DCU 200. The plurality of communication lines connected to each of the DCUs 201 to 204 may comply with different communication protocols.

In the illustrated example, three communication lines that comply with the CAN-FD communication protocol according to which the communication speed is 2 Mbps and three communication lines that comply with the Ethernet (registered trademark) communication protocol according to which the communication speed is 100 Mbps are connected to the DCU 203. Three ECUs 203a to 203c are connected to a first communication line that complies with the CAN communication protocol, ECUs 203d to 203f are connected to a second communication line, and ECUs 203g to 203i are connected to a third communication line. In addition, an ECU 203j is connected to a fourth communication line that complies with the Ethernet (registered trademark) communication standard, an ECU 203k is connected to a fifth communication line, and an ECU 203l is connected to a sixth communication line. Similarly, a plurality of ECUs are connected to each of the DCUs 201, 202 and 204, which is not illustrated.

For example, if the ECU 230j transmits a message, this message is received by the DCU 203. The DCU 203 relays the received message, and determines a relay destination of this message based on the content (e.g., data, header information, or the like) of the message received from the ECU 230j, and transmits the message to a communication line determined as a relay destination. Note that, in the communication system according to Embodiment 2, the DCUs 200 and 201 that received a message do not necessarily need to relay this message to all the communication lines, and it is sufficient that the message is relayed to a communication line that has an ECU that requires this message. In addition, if an ECU that requires the received by one of the DCUs 201 to 204 message is not directly connected to this DCU, the DCU transmits this message to the DCU 200, and thereby transmits the message to a destination ECU via the DCU 200 and another one of the DCUs 201 to 204.

In the communication system according to Embodiment 2, all of the DCUs 200 to 204 and the ECUs 203a to 203l store shared information in their own storage units, and the DCU 200 starts processing for updating shared information at a predetermined timing. Specifically, the DCU 200 generates new shared information, updates shared information stored in the storage unit of the DCU 200 itself, and transmits an instruction to update shared information to the DCUs 201 to 204. Each of the DCUs 201 to 204 that received the update instruction from the DCU 200 updates the shared information stored in its storage unit, and transmits an instruction to update shared information to the six communication lines to which ECUs are respectively connected. For example, the ECUs 203a to 203l that received the update instruction from the DCU 203 update the shared information stored in their storage units.

In addition, in the communication system according to Embodiment 2, during a period from update of shared information until a predetermined period elapses, the DCUs 200 to 204 perform processing for receiving, as a proper message, a message to which a MAC generated using old shared information that is not yet updated is attached and a message to which a MAC generated using new shared information that has been updated is attached, and relaying the message. In addition, at this time, if the DCUs 200 to 204 receive a message to which a MAC generated using old shared information that is not yet updated is attached, the DCUs 200 to 204 perform message correction processing for replacing the MAC in this message with the MAC generated using new shared information that has been updated, and relays the corrected message.

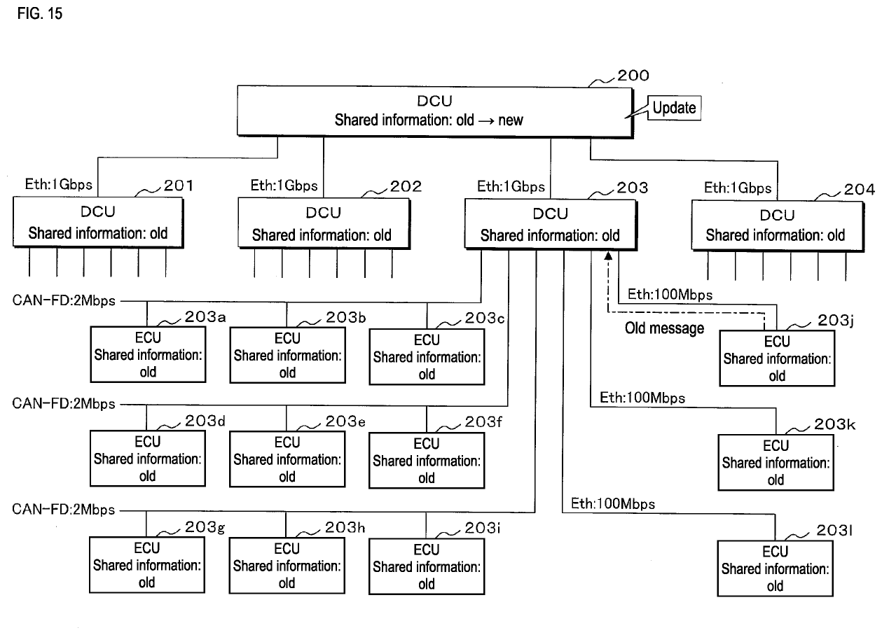

FIGS. 15 to 19 are schematic diagrams showing a first example of message transmission/reception and update of shared information that are performed by the communication system according to Embodiment 2, and time-sequentially show message transmission/reception situations and the like from FIGS. 15 to 19. FIG. 15 shows a situation in which a timing for performing update processing has come, and the DCU 200 has started processing for updating shared information. The DCU 200 generates new shared information, and updates shared information stored in the DCU 200 itself. In the situation shown in FIG. 15, the DCU 200 has not transmitted an update instruction yet, and shared information stored in the DCUs 201 to 204 and the ECUs 203a to 203l is old shared information that is not yet updated. In this situation, the ECU 203j transmits a message to which a MAC generated using old shared information that is not yet updated is attached (indicated by the arrow of a dashed-dotted line in FIG. 15, the same applies to the following drawings), and this message is received by the DCU 203.

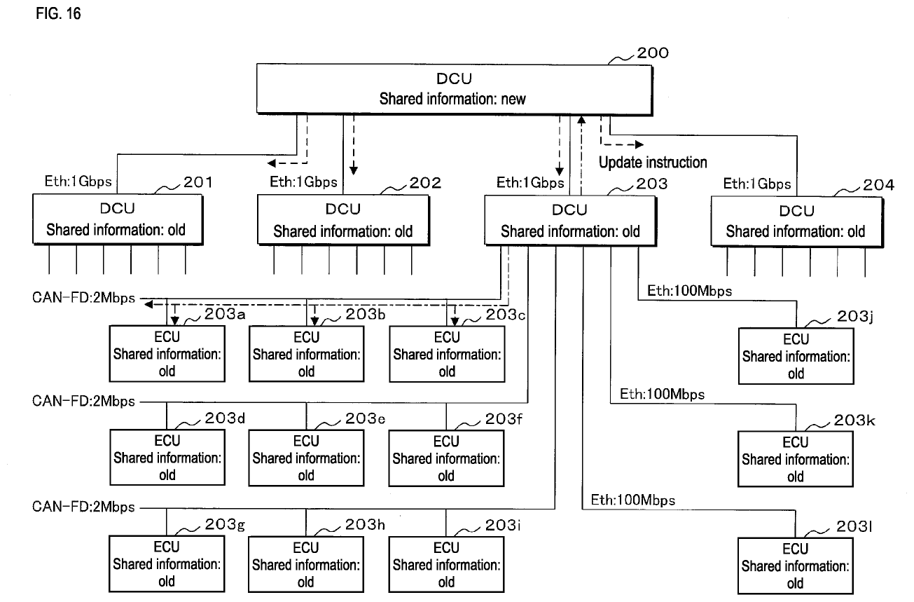

Next, in the situation shown in FIG. 16, the DCU 203 that has received a message from the ECU 203j determines that the received message is proper, based on the MAC included in this message, and transmits the message to communication lines to which the DCU 200 and the ECUs 203a to 203c are connected, to relay this message to the DCU 200 and the ECUs 203a to 203c. Note that the determination at this time is performed by the DCU 203 using old shared information that is not yet updated. The message relayed by the DCU 203 is received by the DCU 200 and the ECUs 203a to 203c. In addition, at this time, slightly after transmission of message that is performed by the DCU 203, the DCU 200 transmits an update instruction of shared information to the DCUs 201 to 204 (indicated by the arrow of a broken line in FIG. 16, and the same applies to the following drawings).

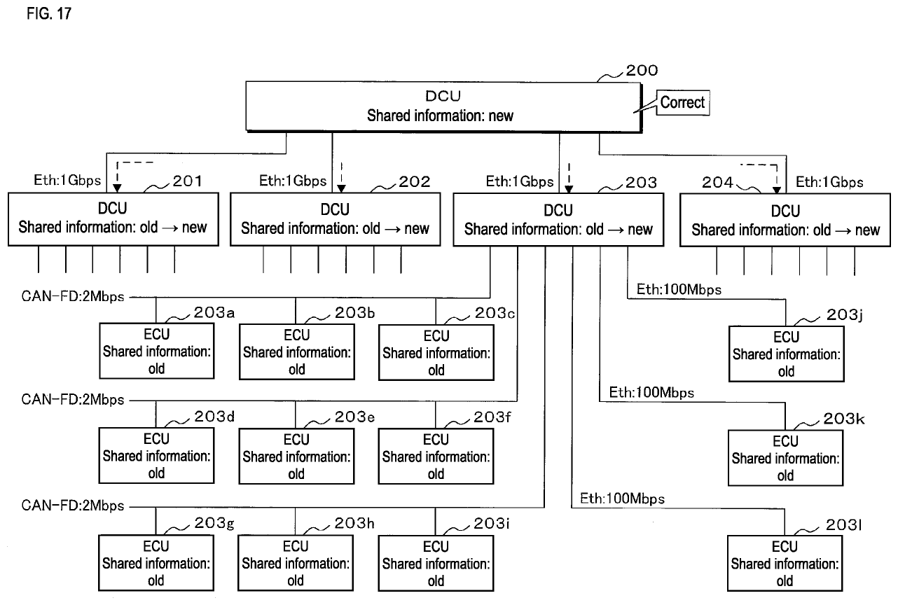

Next, in the situation shown in FIG. 17, the DCUs 201 to 204 that received the update instruction of shared information from the DCU 200 perform update processing, and shared information stored in the DCUs 201 to 204 is updated to new shared information sent from the DCU 200. In addition, at this time, the DCU 200 determines that a message to which a MAC generated using old shared information that has not been updated and has been received from the DCU 203 is attached was received during a period from update of shared information until a predetermined period elapses, generates a MAC using new shared information that has been updated, replaces the MAC included in the received message with the generated MAC, and thereby performs message correction.

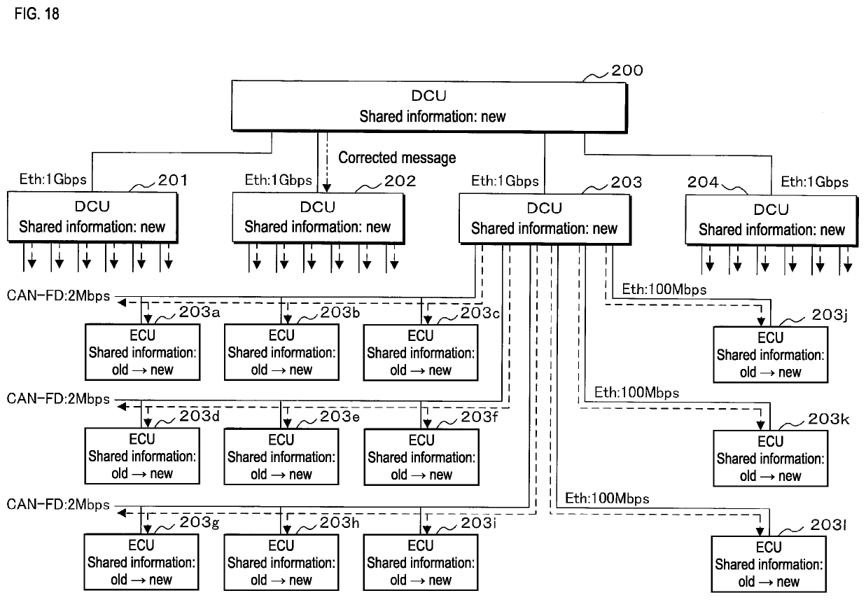

Next, in the situation shown in FIG. 18, each of the DCUs 201 to 204 that completed update of shared information transmits an update instruction of shared information at the same time to all of the communication lines connected to the DCU (note that the communication lines to which the DCU 200 is connected are excluded). For example, the ECUs 203a to 203l that received the update instruction of shared information from the DCU 203 start update processing. In addition, at this time, the DCU 200 that completed correction of the message transmits the corrected message to the DCU 202 (in FIG. 18, indicated by the arrow of a one-dotted-chain line, and the same applies to the following drawings). The message that is transmitted from the DCU 200 at this time is a message to which a MAC generated using new shared information that has been updated is attached, and the DCU 202 that receives this message has completed update processing, and thus can determine, using new shared information that has been updated and is stored in the DCU 202 itself, whether or not the received message is proper.

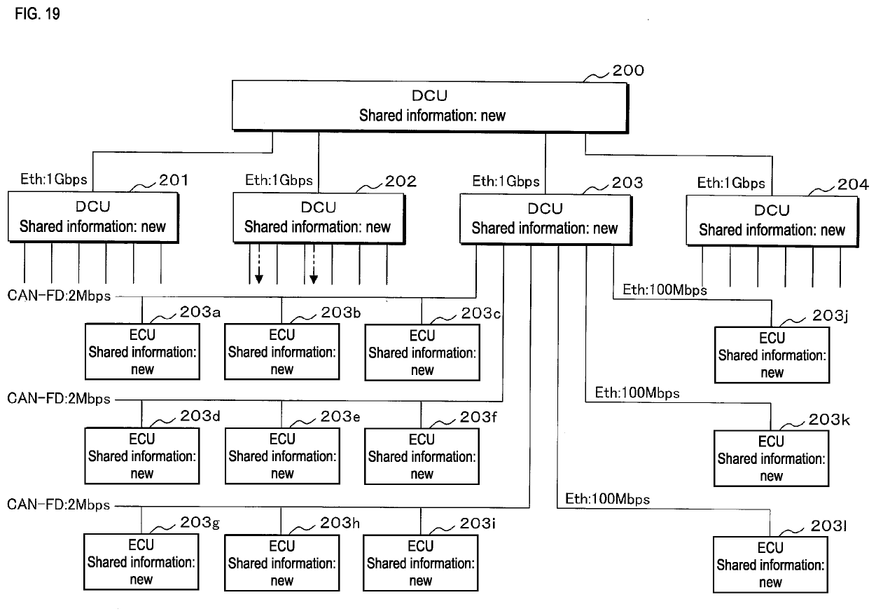

Next, in the situation shown in FIG. 19, the DCU 202 that has determined that the message from the DCU 200 is a proper message relays this message. In addition, the ECUs connected to the DCUs 201 to 204 have completed update of shared information. Thus, each ECU that received the message from the DCU 202 can determine, using new shared information that has been updated and is stored in the ECU itself, whether or not the received message is proper.

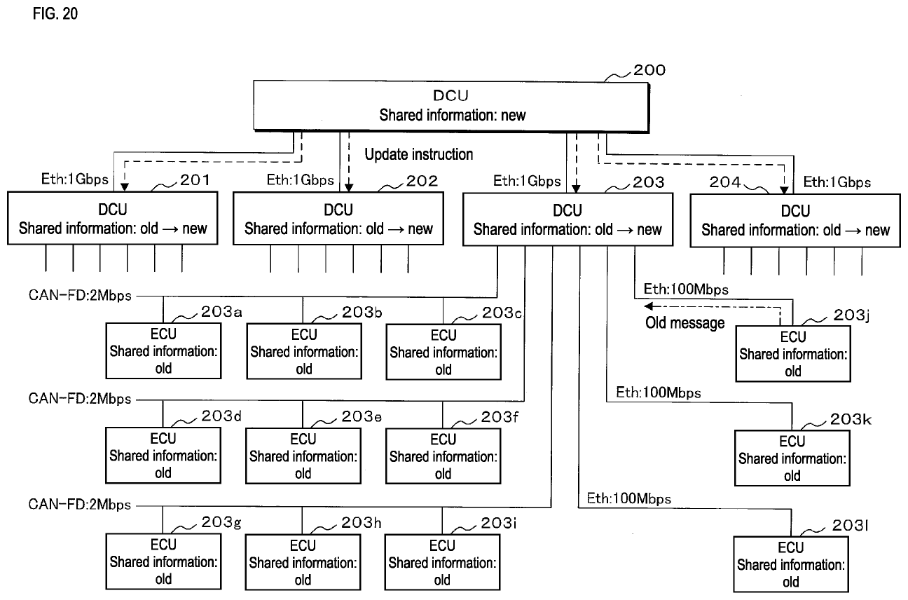

FIGS. 20 to 23 are schematic diagrams showing a second example of message transmission/reception and update of shared information that are performed by the communication system according to Embodiment 2, and time-sequentially show message transmission/reception situations and the like from FIG. 20 to FIG. 23. The situation in the second example is close to the first example, but before the DCU 203 receives, from the ECU 203j, a message to which a MAC generated using old shared information that is not yet updated is attached, the update instruction from the DCU 200 that completed update processing is received by the DCU 203.

In the situation shown in FIG. 20, the DCU 200 that completed update processing transmits an update instruction of shared information to the DCUs 201 to 204 at the same time, and the DCUs 201 to 204 that received this update instruction start update processing. At this time, the ECU 203j transmits, to the DCU 203, a message to which a MAC generated using old shared information that is not yet updated.

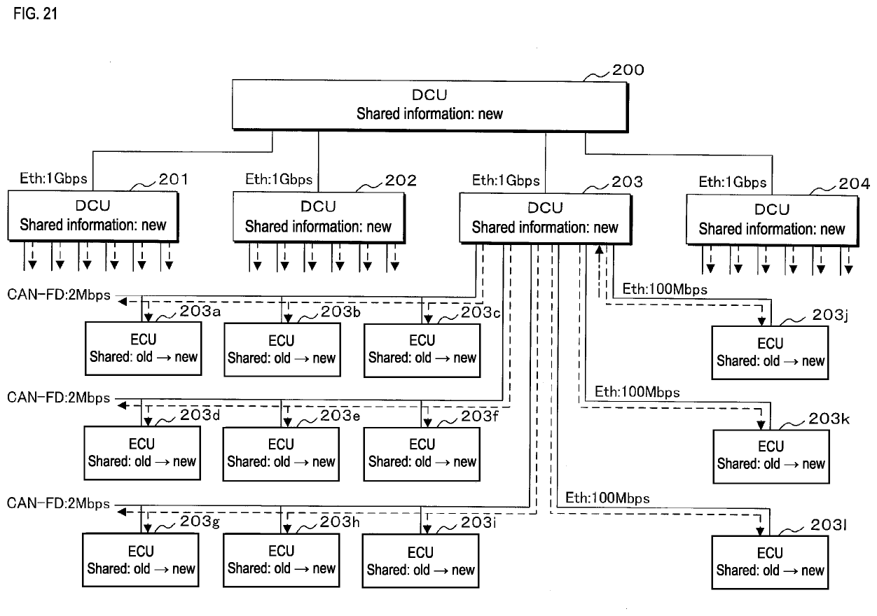

Next, in the situation shown in FIG. 21, the message transmitted by the ECU 203j is received by the DCU 203. In addition, after receiving this message or at the same time as the reception, the DCUs 201 to 204 that completed processing for updating shared information transmit an update instruction of shared information to ECUs at the same time. The ECUs that received the update instruction from the DCUs 201 to 204 start processing for updating shared information stored in the ECUs themselves.

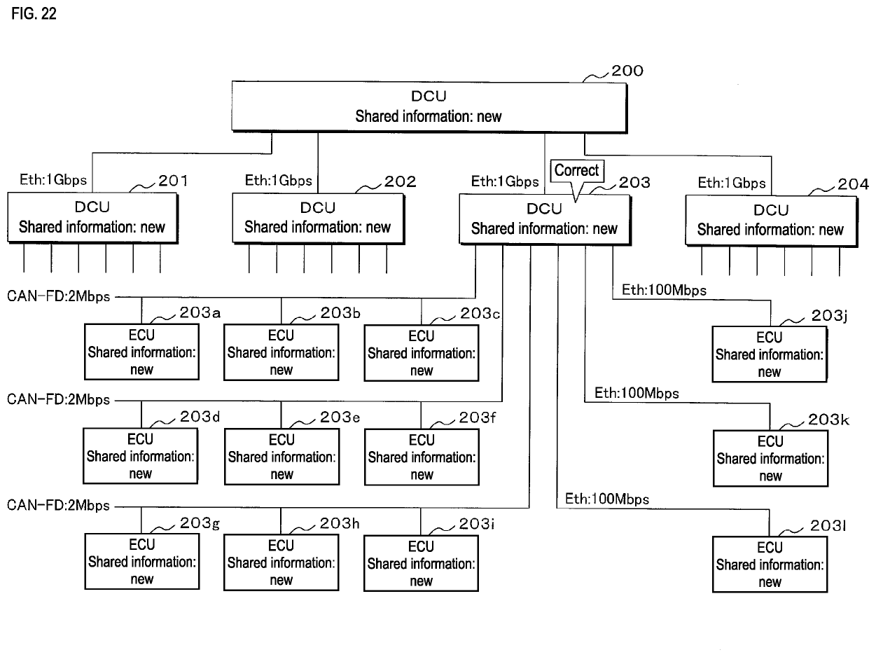

Next, in the situation shown in FIG. 22, the DCU 203 determines that a message to which a MAC generated using old shared information that has not been updated and has been received from the ECU 203j is attached has been received during a period from update of shared information until a predetermined period elapses, generates a MAC using new shared information that has been updated, replaces the MAC included in the received message with the generated MAC, and thereby performs message correction.

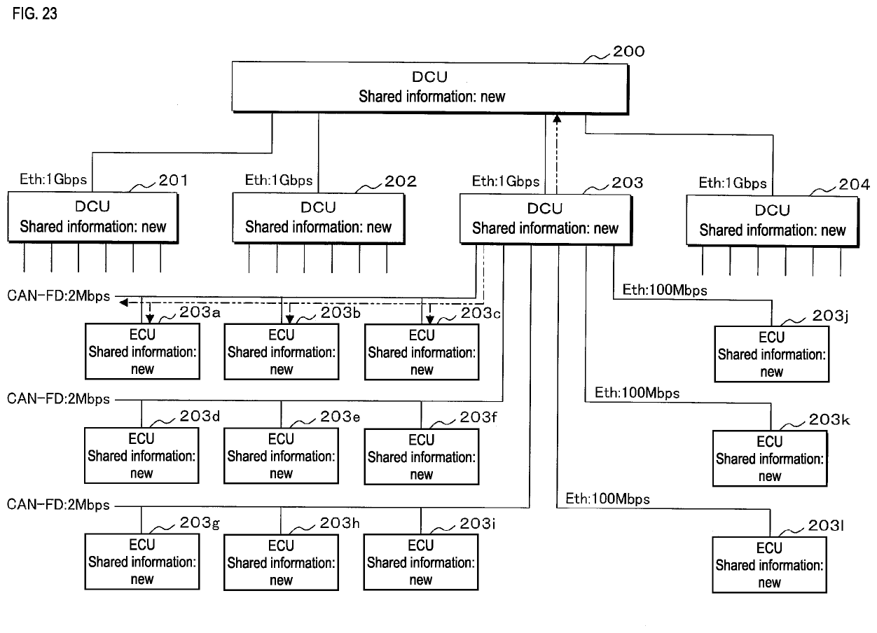

Next, in the situation shown in FIG. 23, the DCU 203 that completed message correction transmits the corrected message to the DCU 200 and the ECUs 203a to 203c. The message that is transmitted from the DCU 203 at this time is a message to which a MAC generated using new shared information that has been updated is attached, and the DCU 200 and the ECUs 203a to 203c that receive this message have completed update processing, and thus can determine whether or not the received message is proper, using the new shared information that has been updated and is stored in the DCU 200 and the ECUs 203a to 203c respectively.

The communication system according to Embodiment 2 that has the above-described configuration is a communication system that adopts so-called domain architecture. Even in a communication system having such a configuration, it is possible to realize message transmission/reception using shared information whose value changes if the DCUs 200 to 204 have a function similar to that of the gateway 4 of the communication system according to Embodiment 1, namely a function for determining that a message in which old shared information that is not yet updated is used and a message in which new shared information that has been updated is used are proper messages, during a period from update of shared information until a predetermined period elapses.

Note that, in Embodiment 2, a configuration has been described in which the DCUs 200 to 204 that are relay devices have a function for determining that both a message in which old shared information that is not yet updated is used and a message in which new shared information that has been updated is used are proper messages, during a period from when update of shared information until a predetermined period elapses, but there is no limitation thereto. As described in Modified Example of Embodiment 1, a configuration may also be adopted in which the ECUs 203a to 203l have this function. In addition, the configuration of the communication system shown in FIGS. 14 to 23, a timing for transmitting a message or update instruction, and the like are merely examples, and there is not limitation thereto.

1. A communication system, wherein one or more communication devices are connected to a communication line, and communication between a plurality of such communication lines is relayed by a relay device,
the communication device and the relay device each comprising:
a storage unit configured to store shared information,
a message generation unit configured to generate a message using the shared information,
a message transmission unit configured to transmit, to another device,
a message generated by the message generation unit,
a message reception unit configured to receive a message from another device, and
a determination unit configured to determine, based on the shared information, whether or not a message received by the message reception unit is proper, and
at least one device out of the communication devices and the relay device includes an update instruction transmission unit that transmits, to the other devices, an update instruction for updating the shared information,
the communication devices and the relay device further include an update unit configured to update shared information stored in the storage unit when the update instruction is received, and
if, during a period from update of the shared information until a predetermined period elapses, the communication devices or the relay device receives a message generated using shared information that is not yet updated, then the determination unit determines that the message is a proper message.

2. The communication system according to claim 1,
wherein the relay device includes a message correction unit configured to correct, if a message generated using shared information that is not yet updated is received during a period from update of the shared information until a predetermined period elapses, the message to a message in which updated shared information is used, and to relay the message corrected by the message correction unit.

3. The communication system according to claim 1,
wherein a message that is generated by the message generation unit includes update state information indicating an update state of the shared information, and
the determination unit is configured to determine whether or not a received message is proper, based on the shared information and the update state information included in the message.

4. The communication system according to claim 3,
wherein the update state information is information whose value changes in accordance with the update instruction based on a predetermined rule.

5. The communication system according to claim 4,
wherein the update state information is a toggle bit whose value is inverted in accordance with the update instruction.

6. The communication system according to claim 1,
wherein a message that is generated by the message generation unit includes a message identifier generated based on the shared information and information included in the message, and
the determination unit is configured to determine whether or not the message is proper, based on information and a message identifier included in a received message and the shared information stored in the storage unit.

7. A relay device that relays communication between a plurality of communication lines, to each of which one or more communication devices are connected, comprising:
a storage unit configured to store shared information that is shared with the communication devices;
a message reception unit configured to receive, from the communication devices, a message generated using the shared information;
a determination unit configured to determine, based on the shared information, whether or not a message received by the message reception unit is proper;
an update unit configured to update shared information stored in the storage unit; and
a message correction unit configured to correct, if a message generated using shared information that is not yet updated is received during a period from update of the shared information until a predetermined period elapses, the message to a message in which updated shared information is used.

8. A communication device that is connected to a communication line to which at least a relay device is connected, and performs communication via the communication line and the relay device, the communication device comprising:
a storage unit configured to store shared information that is shared with the relay device;
a message generation unit configured to generate a message using the shared information;
a message transmission unit configured to transmit, to another device, a message generated by the message generation unit;
a message reception unit configured to receive a message from another device;
a determination unit configured to determine, based on the shared information, whether or not a message received by the message reception unit is proper, and
an update unit configured to update, when an update instruction of the shared information that is transmitted from another device is received, shared information stored in the storage unit,
wherein the determination unit is configured to determine, if a message generated using shared information that is not yet updated is received during a period from update of the shared information until a predetermined period elapses, that the message is a proper message.

9. A communication method,
wherein one or more communication devices are connected to a communication line, and a relay device to which a plurality of such communication lines are connected relays communication between the communication lines,
the communication devices and the relay device store shared information, generate a message using the shared information and transmit the generated message to another device, and determine whether or not a message received from another device is proper, based on the shared information,
at least one device out of the communication devices and the relay device transmits an update instruction to update the shared information, to another device,
the communication devices and the relay device update the shared information when the update instruction is received, and
if a message generated using shared information that is not yet updated is received during a period from update of the shared information until a predetermined period elapses, the communication devices or the relay device determine that the message is a proper message.

10. The communication system according to claim 2,
wherein a message that is generated by the message generation unit includes update state information indicating an update state of the shared information, and
the determination unit is configured to determine whether or not a received message is proper, based on the shared information and the update state information included in the message.

11. The communication system according to claim 2,
wherein a message that is generated by the message generation unit includes a message identifier generated based on the shared information and information included in the message, and
the determination unit is configured to determine whether or not the message is proper, based on information and a message identifier included in a received message and the shared information stored in the storage unit.

12. The communication system according to claim 3,
wherein a message that is generated by the message generation unit includes a message identifier generated based on the shared information and information included in the message, and
the determination unit is configured to determine whether or not the message is proper, based on information and a message identifier included in a received message and the shared information stored in the storage unit.

13. The communication system according to claim 4,
wherein a message that is generated by the message generation unit includes a message identifier generated based on the shared information and information included in the message, and
the determination unit is configured to determine whether or not the message is proper, based on information and a message identifier included in a received message and the shared information stored in the storage unit.

14. The communication system according to claim 5,
wherein a message that is generated by the message generation unit includes a message identifier generated based on the shared information and information included in the message, and
the determination unit is configured to determine whether or not the message is proper, based on information and a message identifier included in a received message and the shared information stored in the storage unit.
